(19) United States
(12) Patent Application Publication
(10) Pub. No.: US 2012/0208104 A1
(43) Pub. Date: Aug. 16, 2012

(54) FUEL CELL

(75) Inventor: Jan Petrus Human, Somerset West (ZA)

(73) Assignee: Mioxide Mining (Pty) Ltd, Waseville, Gauteng (ZA)

(21) Appl. No.: 13/390,912

(22) PCT Filed: Aug. 16, 2010
(86) PCT No.: PCT/IB2010/053688

§ 371 Date: May 1, 2012

(30) Foreign Application Priority Data
Aug. 17, 2009 (ZA) 2009/05685
Dec. 23, 2009 (ZA) 2009/09200

(51) Int. Cl. H01M 8/02; C25B 9/08; H01M 2/30

(52) U.S. Cl. 429/517; 204/266

(57) ABSTRACT

A fuel cell is disclosed which comprises a casing (12) and an electrode assembly in the casing. The electrode assembly comprises a porous substrate (36) and first and second electrodes (46, 48) on one side of the substrate. Third and fourth electrodes (60, 62) are provided on the other side of the substrate. Each electrode includes a tab (36, 38, 42, and 44) by means of which an electrical connection can be made to that electrode. There is electrolyte in the casing.

### FIELD OF THE INVENTION

This invention relates to hybrid structures usable as fuel cells and as hydrogen generators, and which can also serve as storage batteries.

### BACKGROUND TO THE INVENTION

Fuel cells have been of interest for over 150 years as a potentially more efficient and less polluting means of converting hydrogen and carbonaceous or fossil fuels to electricity as compared to conventional heat engines. Investigations into the use of fuel cells in generating utility power and for driving electrical vehicles have taken place over a considerable period of time, but development has been slow. Recent advances in fuel cell technology have revitalized interest in such cells for these applications and also new applications.

A conventional fuel cell, when its terminals are connected to an external source of electrical power, evolves hydrogen and oxygen. Such a cell can be operated in reverse and be supplied with hydrogen and oxygen (which can be the oxygen in atmospheric air). It then generates electrical power which manifests itself in the form of a voltage across the terminals.

In conventional commercially available fuel cells, supply of electrical power and the consequent generation of hydrogen and oxygen, occurs at a different time to the supply of hydrogen and oxygen and the consequent generation of electrical power. The two modes of operation cannot be simultaneous.

The flow of electricity from the fuel cell depends on a number of factors, the rate of consumption of hydrogen being the significant one. The configuration of the channels through which the hydrogen and oxygen flows also influences the rate at which the reactions from which the electron flow takes place.

Cells in which an electrolyte (which can be water) is hydrolysed are also known, these cells producing hydrogen and oxygen. The hydrogen, which is the requisite product of the electrolysis, is collected and stored. The oxygen is of lesser value and is quite often simply allowed to escape to atmosphere.

Many types of electrochemical cells which have positive and negative plates and which store electricity in chemical form are known and are in widespread use.

Some cells, as mentioned above, by virtue of the reversible reactions which occur in them, can be used both as hydrogen generators and as generators of electricity. Supply of hydrogen and either oxygen or an atmospheric air result in the production of electricity, that is, the cell is operating as a fuel cell. Connection of a DC supply across the terminals of the cell results in electrolysis taking place in the electrolyte, with the consequent generation of hydrogen and oxygen.

The present invention provides a fuel cell in which supply of electrical power with the consequent generation of hydrogen and oxygen, and the generation of electrical power which can be fed to a power consuming device, occur simultaneously.

Another inventive concept disclosed herein is that these structures (fuel cell, electrolysis cell and electrochemical storage cell) can be combined in constructions that result in significant advantages over the individual structures.

The invention extends to electrolysis cells which are connected to a DC source so that they produce hydrogen and oxygen, but which also have terminals from which power can be taken.

Fuel cells which have electrochemical storage capacity are also possible in accordance with the present invention.

Structures which act as fuel cells, electrolysis cells and storage batteries can also be constructed in accordance with the present invention

### BRIEF DESCRIPTION OF THE INVENTION

According to one aspect of the present invention there is provided a fuel cell comprising a casing and an electrode assembly in the casing, the electrode assembly comprising a porous substrate, a first electrode on one side of the substrate, a second electrode on said one side of the substrate, a third electrode on the other side of the substrate, a fourth electrode on the other side of the substrate, each electrode including a tab by means which an electrical connection can be made to that electrode, and electrolyte in the casing.

The present invention also provides an installation comprising a fuel cell as defined in the preceding paragraph, a current source connected across the first and third terminals, and a power consuming device connected across the second and fourth terminals.

More than two electrodes can be provided on each side of the substrate so that more than one current source can be connected to the cell, and more than one power consuming device can be connected to the cell.

The installation, according to the present invention, has current flowing through the electrolyte from the first electrode to the third electrode, whilst simultaneously power is being taken, at said second and fourth terminals, from the installation to drive said power consuming device.

According to another aspect of the present invention there is provided a structure which comprises first and second electrically conductive plates which are immersed in electrolyte, have a multitude of holes in them to increase their surface area and have tabs for connection to a source of DC current whereby current flowing between the plates disassociates the electrolyte so that hydrogen and oxygen are evolved, third and fourth electrically conductive plates between the first and second plates and separated from one another and from the first and second plates by gas permeable membranes, the third and fourth plates having tabs to which a power consuming device can be connected, electron flow through said device occurring when, in use, oxygen and hydrogen permeate through the plates and membranes to recombine on the third plate.

The first and second plates can each comprise two metal plates which form plate substrates and which are separated by an electrically insulating mesh, the substrates and mesh of the first plate being pasted with an electrochemically active positive material and the substrates and mesh of the second plate being pasted with an electrochemically active negative material, each substrate having a tab, the first and second plates constitutes an electrical storage battery.

In a further form there is an electronically insulating mesh between the first and third plates and a further electrically insulating mesh between the second and fourth plates, the first and third plates and the intervening mesh being pasted with electrochemically active positive material to form a composite plate and the second and fourth plates and the intervening mesh being pasted with electrochemically active negative material to form a further composite plate, the composite plate being separated by a gas permeable membrane.

The plates and membranes can be of rectangular form.

Said structures can be contained in a casing which has a groove in extending down the internal face of each side wall and across the top face of the bottom of the casing, said structure fitting in a gas and liquid tight manner in said groove.

There can be a compartment on each side of said structure.

A lid with holes in it is provided for closing-off said casing.

In another embodiment each plate and membrane is in the form of an elongate strip, the structure being rolled and contained in a cylindrical casing.

According to a further aspect of the present invention there is provided an installation comprising a structure as defined above, a power consuming device connected across the tabs of the third and fourth plates, and, a source of DC current connected across the tabs of the first and second plates.

### BRIEF DESCRIPTION OF THE DRAWINGS

For a better understanding of the present invention, and to show how the same may be carried into effect, reference will now be made, by way of example, to the accompanying drawings in which:

FIG. 1 is a pictorial view showing the components of a fuel cell in accordance with the present invention;

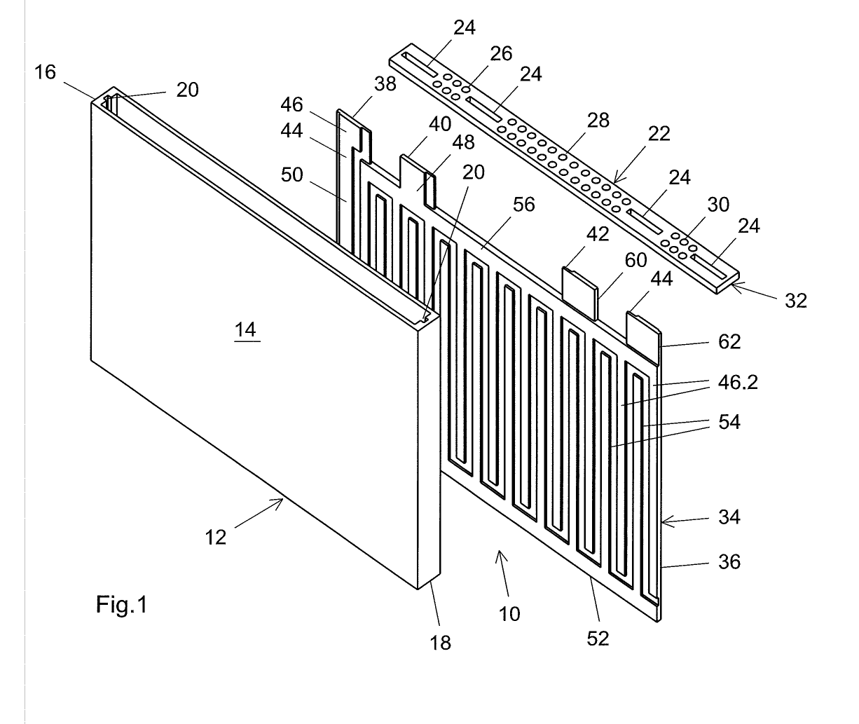

FIG. 2 is a pictorial view of the fuel cell partially assembled;

FIG. 3 is a pictorial view of the fuel cell fully assembled;

FIG. 4 diagrammatically illustrates the individual components of a cell operable as a fuel cell or hydrogen generator;

FIG. 5 diagrammatically illustrates the components of a hybrid battery and fuel cell;

FIG. 6 shows the components of FIG. 5 juxtaposed to one other;

FIG. 7 is a pictorial view of the components of FIGS. 5 and 6 in an outer casing;

FIG. 8 diagrammatically illustrates the components of a further hybrid battery and fuel cell;

FIG. 9 illustrates a cylindrical hybrid fuel cell and battery; and

FIG. 10 illustrates a further embodiment of the invention.

### DETAILED DESCRIPTION OF THE DRAWINGS

The fuel cell illustrated is designated 10 and comprises a casing 12 which includes two elongate side walls 14, two narrow end walls 16 and a base 18. A vertical groove 20 extends the full height of the inner face of each end wall 16. A lid 22 for the casing 12 has four slits 24 and three sets of holes 26, 28 and 30 alternating with the slits 24. The grooves 20 in the end walls 16 are continued across the top surface of the base 16 and across the underside of the lid 22. The groove in the top surface of the lid is designated 32.

Reference numeral 34 designates the electrode assembly of the fuel cell. The assembly 34 comprises a substrate 36 which is porous so that electrolyte in the casing 12 can permeate through from one side to the other. The substrate 36 is of a material such as polyethylene so that it acts as an electrical insulator. The substrate is formed with four upwardly protruding tabs 38, 40, 42 and 44.

Two tracks 46, 48 of electrically conductive metal such as lead are provided on the visible face of the substrate 36.

The track 46 commences on the visible face of the tab 38 and has a section 50 which extends down the left hand edge of the substrate 34 and a further section 46, 52 which extends across the bottom edge of the substrate 36. A series of spaced strips 54 extend upwardly from the section 52.

The track 48 commences on the tab 40 and includes a section 56 which extends across the top edge of the substrate and a series of strips 58 which extend downwardly from the track section 56. The strips 54 and 58 alternate with one another and are spaced from one another.

The tracks 46 and 48 constitute two electrodes.

The arrangement of the tracks 46, 48 on the visible face of the substrate is repeated on the face which cannot be seen. These tracks commence one on the tab 42 and the other on the tab 44. Just those portions of these tracks which are on the tabs 42 and 44 can be seen and are designated 60 and 62.

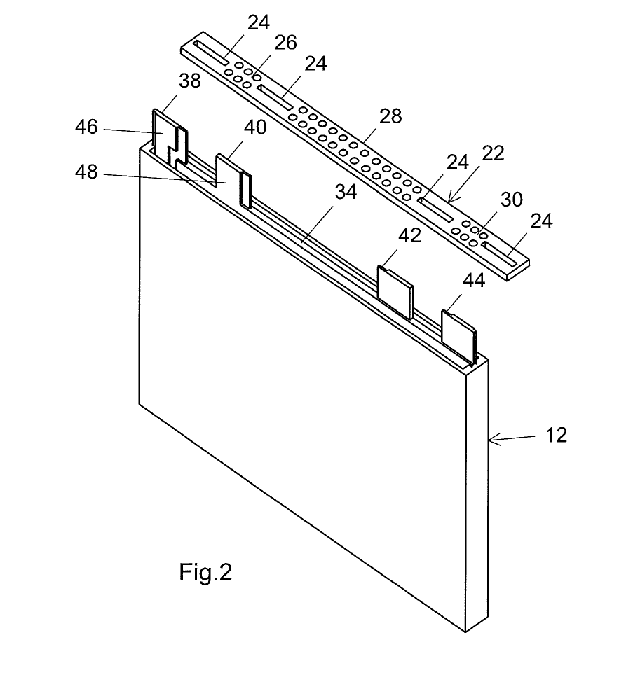

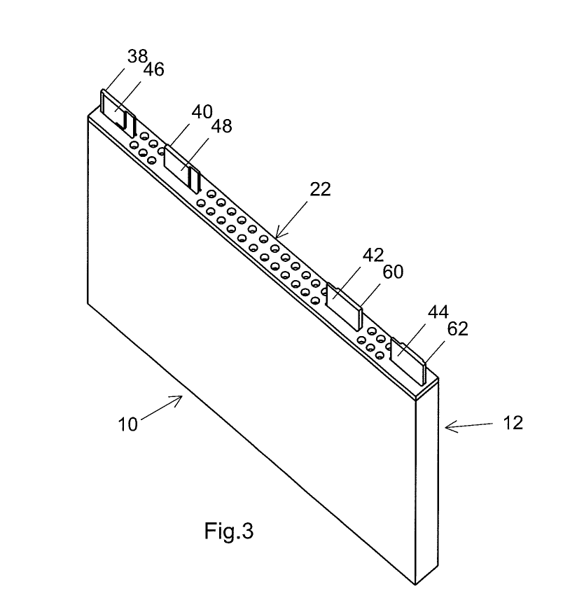

The electrode assembly 34 is slid into the grooves 20 (see FIG. 2) with the tabs 38, 40, 42 and 44 protruding from the casing 12. The casing is filled with electrolyte and the lid 22 pressed on so that the tabs protrude above the lid 22 through the slits 24 (see FIG. 3). The electrode assembly's lower edge is in the groove in the base 18 and the assembly's upper edge is in the groove 32 in the lid 22. The parts of the tracks 46, 48 on the tabs are accessible and can have electrical connections made thereto. A source of electrical current is connected to the tab of one of the visible tracks 46, 48 and to the tab of one of the tracks on the other side of the substrate. A power consuming device is connected to the other track 46, 48 and to the other of the tracks on the other side of the substrate. More specifically, the charging power source can be connected between the part of the track 46 on the tab 38 and the part of the track on the tab 44. The power consuming-device can be connected across the part of the track 48 on the tab 40 and the part of the track on the tab 42. The track on the tab 44 serves as the anode and the track 46 as the cathode. Likewise the track on the tab 42 can serve as the other anode and the track on the tab 40 as the other cathode.

Experimental work has shown that oxygen and hydrogen are evolved at the electrodes to which the source of current is connected and power can be extracted from the other two electrodes. The rate at which oxygen and hydrogen are evolved is dependant on the difference between the rate of charging and the rate of discharging. As the difference increases, the rate of charging being higher than the rate of discharging, gas evolution increases. The hydrogen ions evolved at the anode permeate through the separator 34 and combine with the oxygen being evolved at the cathode. The products of the hydrogen/oxygen reaction are water and electrical energy. If the electrolyte is acidic, water is produced at the cathode. If the electrolyte is alkaline, water is produced at the anode.

If the difference between the charging and discharging rates becomes sufficiently great, the rate of oxygen and hydrogen production will exceed the rate at which it is consumed in the cell and will bubble-off for collection and storage.

The four tracks can be produced using a substrate which has a thin layer of copper on each side. The layers are masked to protect the areas of copper which are to be retained and the exposed copper is etched away. After the masks are removed, the remaining copper is plated with an acid resistant metal such as lead, cadmium, lithium or nickel or with an acid resistant metal hydride. It is possible that, in use, the remaining unplated copper will be eroded but the acid resistant metal remains.

In an alternative form, the substrate 36 has grooves in both faces thereof, the tracks being in the grooves. The tracks can be cast or otherwise formed and then pressed into the grooves. Suitable means, such as interlocking parts of the grooves and tracks, can be provided for securing the tracks in place.

The holes 26, 28 and 30 have various uses. They can be used to replenish the electrolyte in the cell, to enable evolved hydrogen and oxygen to be removed from the cell and to enable hydrogen and air/oxygen to be supplied to the cell.

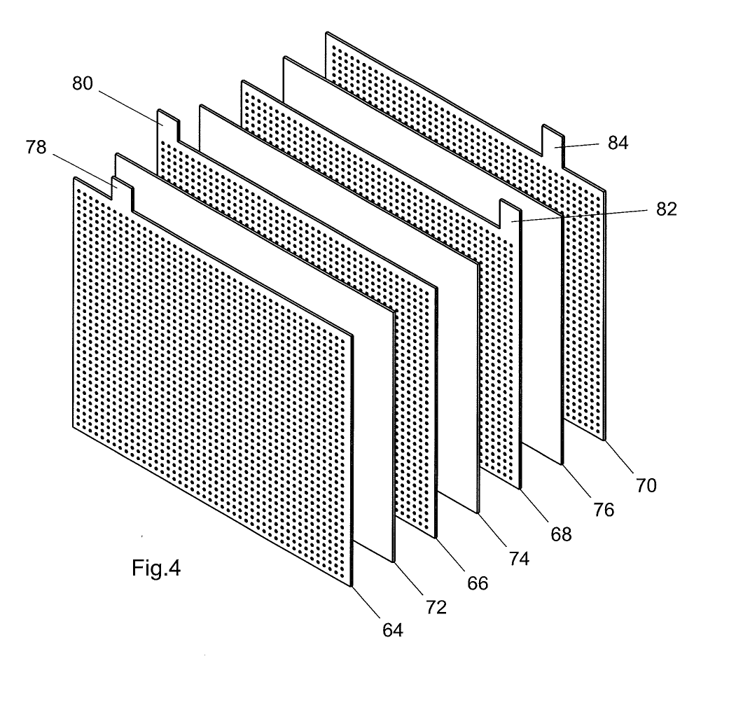

Referring now to FIG. 4 the components illustrated are four electrically conductive plates, which can be lead plates, designated 64, 66, 68 and 70 and three gas permeable membranes designated 72, 74 and 76 which are between the plates 64 and 66, 66 and 68, and 68 and 70. Each plate 64, 66, 68 and 70 has in it a multitude of through holes which have the effect of increasing the surface areas of the plates which are exposed to the electrolyte as will be described. The holes are as small as possible consistent with the manufacturing technique used for their construction. The members 72, 74 and 76 act as separators.

The minimum size of hole that can be formed in lead plates by drilling or casting is larger than optimum. A possible method of reducing the hole size is to drill a plate to produce the holes or cast a plate with holes. The plate is thicker than is required and the plate is then compressed to reduce both its thickness and the sizes of the holes in the plate.

The holes perform the function of the channels in known fuel cells.

Each plate includes a tab, the tabs being designated 78, 80, 82 and 84. The membranes 72, 74 and 76 can be of a suitable synthetic plastics material. Polyethylene is a suitable material. “Nafion” is also a suitable material.

The tabs 78 and 84 can be connected to a source of DC current. The tabs 80 and 82 are connected into a circuit which includes a power consuming device. When a DC voltage is applied to the tabs 78 and 84, the resultant current dissociates the electrolyte. Oxygen is evolved on both sides of the plate 64 and hydrogen is evolved on both sides of the plate 70.

Oxygen permeates through the membrane 72 and the holes in the plate 66 and hydrogen permeates through the membrane 76, through the holes in the plate 68 and through the membrane 74 to the plate 66. Recombination occurs between the plate 66 and the membrane 74 and there is a consequent flow of electrons through the external circuit connected to the tabs 80 and 82.

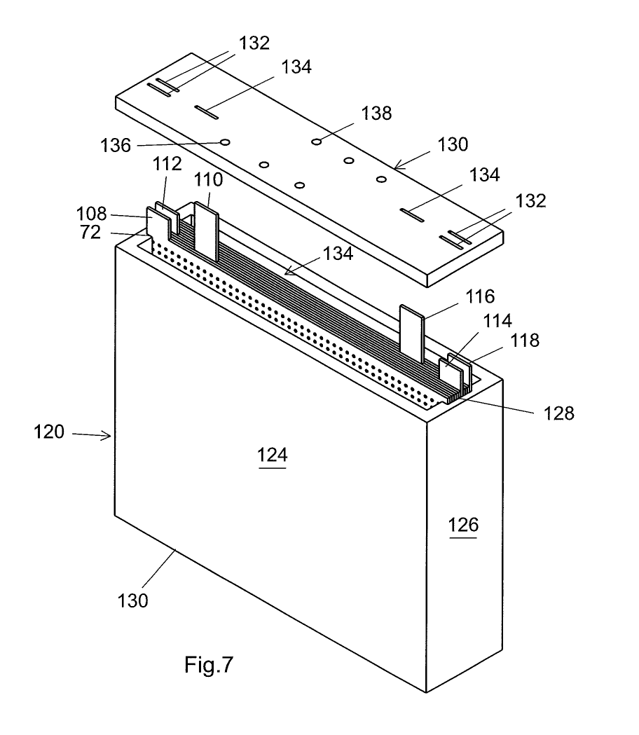

The rate of hydrogen flow through the plates and membranes can be regulated by withdrawing hydrogen from a compartment adjacent the plate 70. This structure will be better understood when reference is made to FIG. 7.

Ambient air can be fed into a compartment which is to the left of the plate 64 to increase the amp hour capacity. Instead of withdrawing hydrogen, hydrogen can be introduced into the compartment to the right of the plate 70 to further increase the amp hour capacity.

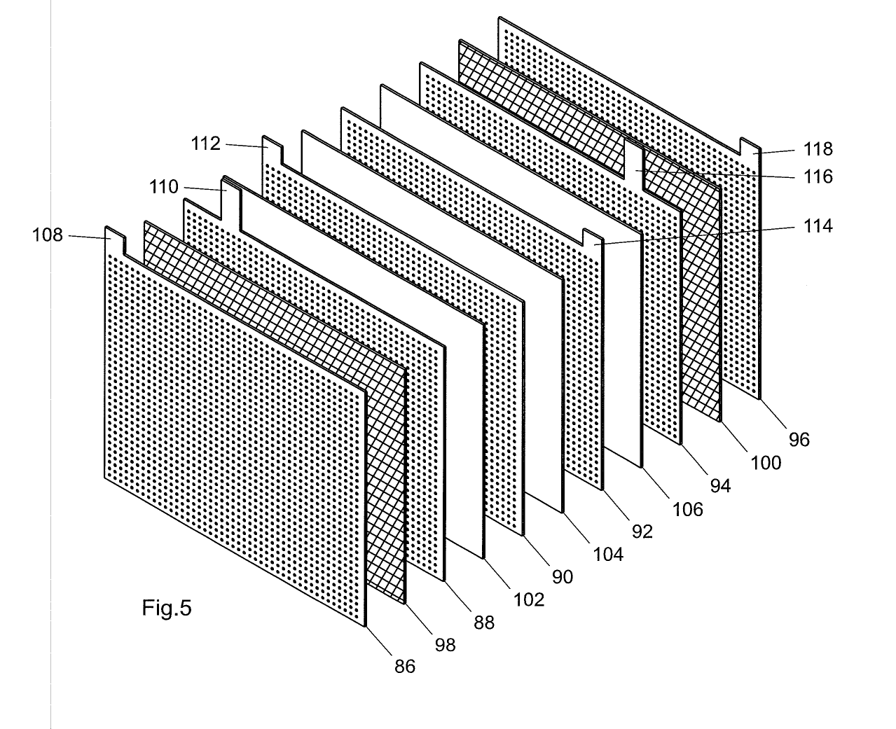

Turning now to FIG. 5, the components shown comprise six electrically conductive plates of the same form as described above and illustrated in FIG. 4. The plates are designated 86, 88, 90, 92, 94 and 96. The plates 86 and 88 are pasted with electrochemically active positive material. The plates 94 and 96 are pasted with electrochemically active negative material. The plates 90 and 92 are not pasted. Between the plates 86 and 88 there is a mesh separator 98 and a further mesh separator 100 is provided between the plates 94 and 96. Gas permeable membranes 102, 104 and 106 are provided between the plates 88 and 90, 90 and 92, and 92 and 94.

When the plates 86 and 88 are pasted, the paste passes through the interstices of the mesh separator 88. Likewise paste passes through the mesh separator 100 when the plates 94 and 96 are pasted. The mesh separator 98 prevents direct contact between the metal plates 86, 88 and the mesh separator 100 prevents contact between the plates 94, 96.

Each plate includes a tab, the tabs being designated 108, 110, 112, 114, 116 and 118.

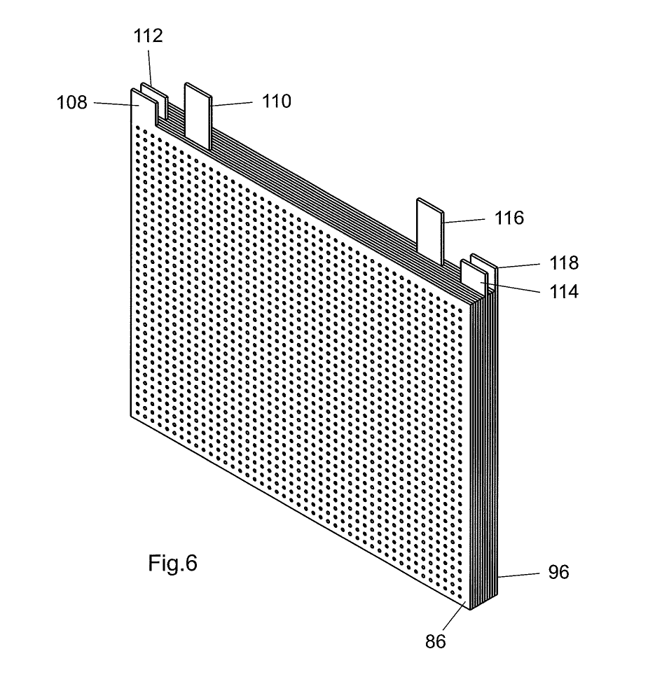

The components of FIG. 5 are shown assembled in FIG. 6 and in FIG. 7 the assembled components are within a casing designated 120. The side walls 124 of the casing 120 are relatively long compared with the end walls 126. Each end wall 126 has an internal groove 128 which extends the full height of the casing. The grooves 128 are continued in the top surface of the base 130 of the container and the assembly shown in FIG. 5 slides into the grooves 128 and seats in the groove in the base. The fit is such that the compartments designated 132 and 134 which lie one on each side of the assembly are sealed-off from one another.

A lid 130 is provided for closing the casing of 120 in a gas tight manner. The lid 130 has in it slots 132 and 134 for the tabs of the assembly shown in FIG. 6. The lid also has holes 136 and 138 for feeding gas to, or allowing gas to escape from, the compartments 132 and 134. The holes can also be used to replenish the electrolyte if required.

It will be understood that the components of FIG. 4, when placed side-by-side, fit into a casing of the type shown in FIG. 7 thereby providing compartments adjacent the plates 64 and 66.

The plates 86, 88 and 94, 96 constitute an electrochemical storage battery and the unpasted plates 90 and 92 constitute a fuel cell. The tabs 110, 116 are connected to the negative and positive respectively of a source of DC current. A power consuming device is connected across the tabs 112 and 114. The tabs 108 and 116 are connected into a circuit which also includes a power consuming device.

Current flows through the assembly illustrated from the source of DC current and simultaneously power is extracted by way of the tabs 108, 118, 112 and 114.

When a DC voltage is applied across the tabs 110, 116, the current that flows dissociates the electrolyte. Oxygen is evolved on the plate 88 and hydrogen is evolved on the plate 94.

Oxygen permeates through the membrane 102 and plate 90. Hydrogen permeates through the membrane 106, the plate 92 and the membrane 104. Recombination of hydrogen and oxygen occurs between the membrane 104 and the plate 90. There is consequently a flow of current between tabs 112 and 114.

If there is an open circuit across tabs 108 and 118, the battery constituted by the plates 86, 88 and 94, 96 charges. If there is a power consuming device across the tabs 108 and 118, power is taken from the assembly whilst simultaneously the battery is charged.

The reactions discussed in the preceding two paragraphs occur simultaneously.

As described above, ambient air or oxygen can be supplied to the compartment 132. Hydrogen can be supplied to the compartment 134 to increase the amp hour capacity.

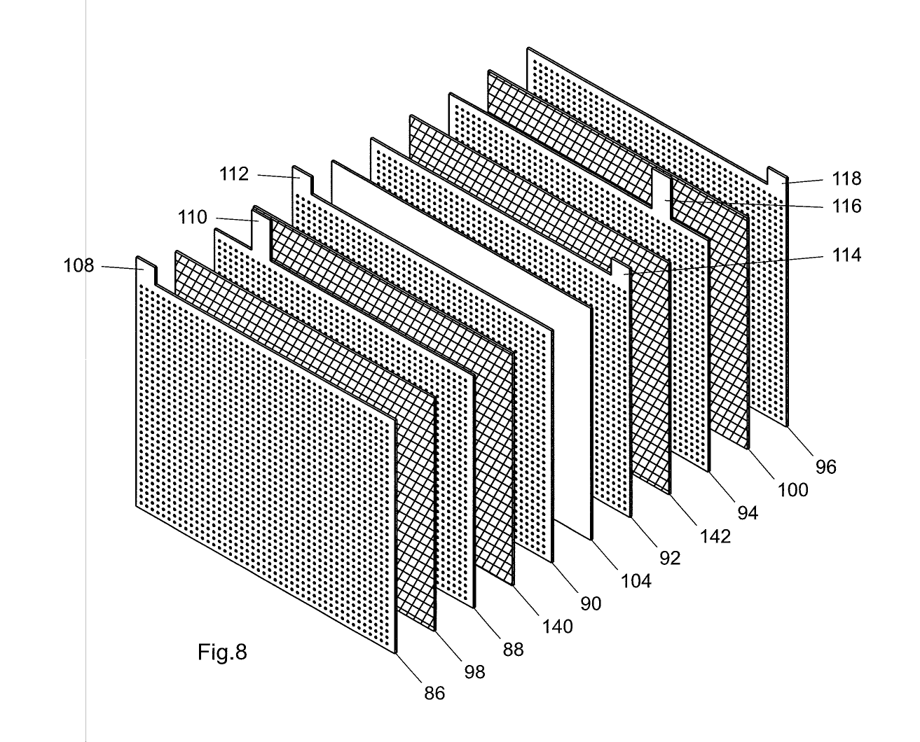

The assembly illustrated in FIG. 8 has many components in common with the assembly shown in FIG. 5 and like parts have been designated by like reference numerals. The gas permeable membranes 102 and 106 have been omitted and two meshes designated 140 and 142 inserted between the plates 88 and 90, and 92 and 94 respectively.

In this embodiment the plates 86, 88 and 90 are all pasted with electrochemically active positive material and the plates 92, 94 and 96 are pasted with electrochemically active negative material. The resultant pairs of plate assemblies are one positive and one negative and these constitute an electrochemical storage cell. The tabs in FIG. 8 are referenced in the same way as the tabs in FIG. 5 and are connected to external circuits in the same way as described above with reference to FIG. 5.

The outer plates 86 and 96 constitute an electrical storage cell whereas the inner plates 88, 90, 92 and 94 constitute both a hydrogen generator and a fuel cell.

Oxygen is evolved on plate 88 and hydrogen on the plate 94. The hydrogen permeates through the plate 92 and the membrane 104 and recombines with the oxygen between the plate 90 and membrane 104. Current flows through the circuit connected across the tabs 112 and 114.

Battery power can be taken off the tabs 108 and 118. Power can also be taken off the tabs 112 and 114, this power being partially derived from the electrochemical reactions in the battery plates and partially from the recombining hydrogen and oxygen.

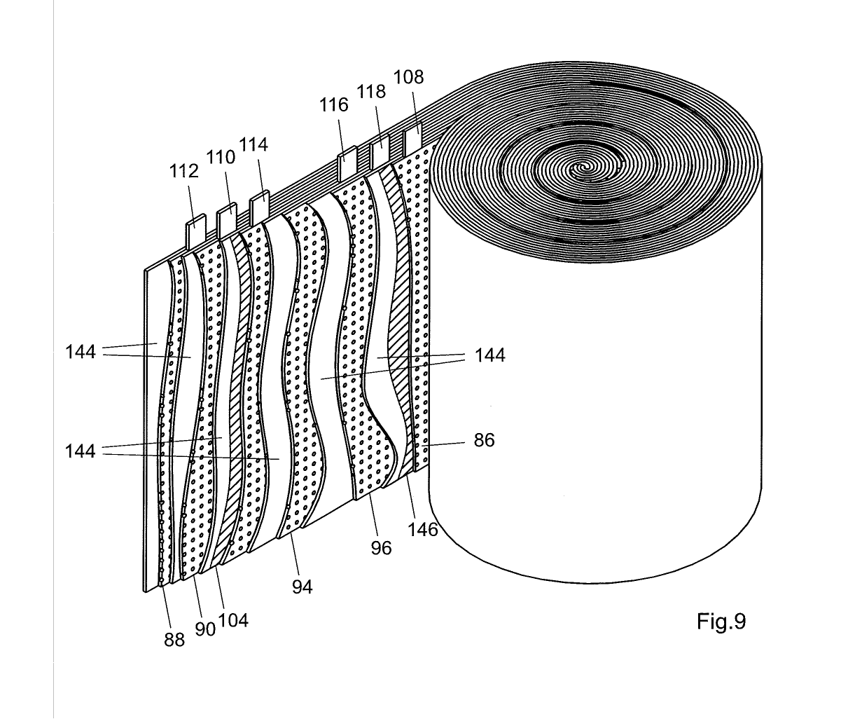

The cylindrical structure shown in FIG. 9 is of substantially the same construction as the prismatic structures described above. The components in FIG. 9 have been referenced using the same numerals as in FIG. 8. Reference numerals 144 designate the paste on the illustrated plates.

There is an additional gas permeable membrane designated 146 which is required to enable the structure to be rolled without permitting contact between pasted plates of opposite polarity.

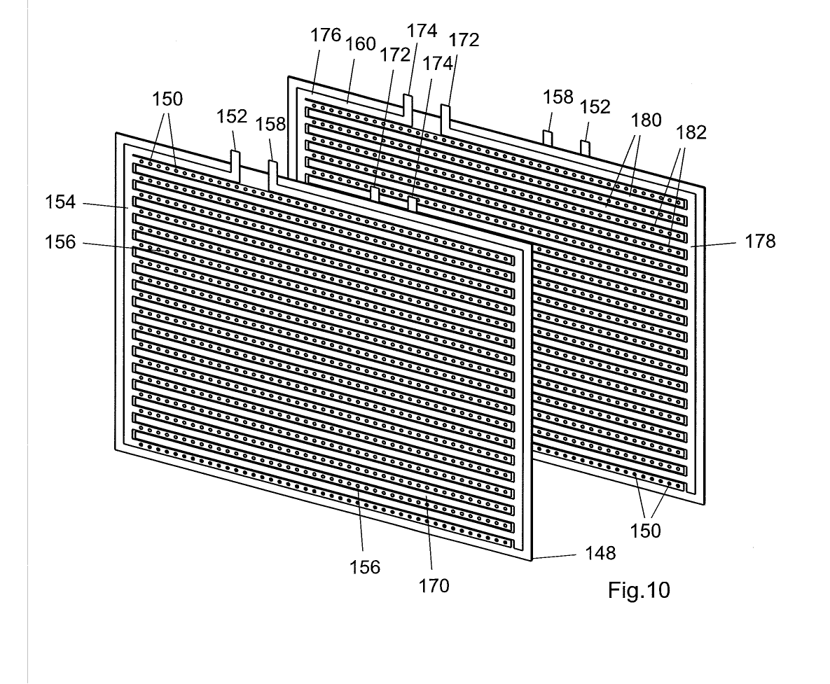

FIG. 10 illustrates a plate 148 from opposite sides. More specifically the rear illustration is of the hidden side of the plate shown in the front illustration. The plate has in it spaced-apart rows of minute holes designated 150. The holes can be filled with gas permeable material as described above.

A first tab 152 is connected to a metal track 154 which extends across the top of the plate and then down the left hand edge. Spaced metal strips 156 extend across the face of the plate 142 and are connected to the track 154. The holes 150 pass through the strips 156.

A second tab 158 is connected to a track 160 which extends down the other edge of the plate 148. Strips 170 of metal extend across the plate 148 and are interdigitated with the strips 156. The strips 156 and 170 are electrically isolated from one another.

The opposite side of the plate 148 is similarly configured and includes tabs 172 and 174, tracks 176 and 178 and strips 180 and 182. The holes 150 pass through the strips 182.

The plate is in use immersed in electrolyte.

When a DC voltage is applied across tabs 158 and 172, oxygen is evolved on the solid strips 156 on one side of the plate and hydrogen on the other side of the plate on the strips 182 through which the holes 150 pass. The hydrogen permeates through the holes 150 and recombines with the oxygen on the other side of plate.

Oxygen or ambient air is supplied to the face at which recombination is occurring to increase the amp hour capacity.

The side of the plate on which the hydrogen is evolved can be pasted negative and the side on which recombination is occurring can be pasted positive.

If the electrolyte used with any of the illustrated construction is an acid, hydrogen is evolved at the negative side and if the electrolyte is alkaline, hydrogen is evolved on the positive side.

The sub-structure of the plate can be lead and there is preferably a coating of nickel.

Platinum can also be used as the sub-structure.

The electrochemically active materials can be based on nickel, lead, hydrides, oxides and carbon. The porosity of the electrochemically active material increases the surface area on which hydrogen and oxygen production, and the recombination of hydrogen and oxygen can take place.

1. A fuel cell comprising a casing and an electrode assembly in the casing, the electrode assembly comprising a porous substrate, a first electrode on one side of the substrate, a second electrode on said one side of the substrate, a third electrode on the other side of the substrate, a fourth electrode on the other side of the substrate, each electrode including a tab by means which an electrical connection can be made to that electrode, and electrolyte in the casing

2. A fuel cell as claimed in claim 1, wherein more than two electrodes are provided on each side of the substrate.

3. An installation comprising a fuel cell as claimed in claim 1 current sources connected across the pairs of first and third terminals.

4. An installation comprising a fuel cell as claimed in claim 3, power consuming devices connected across the pairs of second and fourth terminals and current sources connected across the pairs of first and third terminals.

5. A structure which comprises first and second electrically conductive plates which are immersed in electrolyte, have a multitude of holes in them to increase their surface area and have tabs for connection to a source of DC current whereby current flowing between the plates disassociates the electrolyte so that hydrogen and oxygen are evolved, third and fourth electrically conductive plates between the first and second plates and separated from one another and from the first and second plates by gas permeable membranes, the third and fourth plates having tabs to which a power consuming device can be connected, electron flow through said device occurring when, in use, oxygen and hydrogen permeate through the plates and membranes to recombine on the third plate.

6. A structure as claimed in claim 5, wherein the first and second plates comprises two metal plates which form plate substrates and which are separated by an electrically insulating mesh, the substrates and mesh of the first plate being pasted with an electrochemically active positive material and the substrates and mesh of the second plate being pasted with an electrochemically active negative material, each substrate having a tab, the first and second plates constitutes an electrical storage battery.

7. A structure as claimed in claim 5, and including an electrically insulating mesh between the first and third plates and a further electrically insulating mesh between the second and fourth plates, the first and third plates and the intervening mesh being pasted with electrochemically active positive material to form a composite plate and the second and fourth plates and the intervening mesh being pasted with electrochemically active negative material to form a further composite plate, the composite plate being separated by a gas permeable membrane.

8. A structure as claimed in claim 5, wherein the plates and membranes are of rectangular form.

9. The combination of a structure as claimed in claim 5, and a casing in which the structure is contained, the casing having a groove extending down in the internal face of each side wall and across the top face of the bottom of the casing, said structure fitting in a gas and liquid tight manner in said groove.

10. The combination claimed in claim 9, wherein there is a compartment on each side of said structure.

11. The combination claimed in claim 9 and further including a lid for closing-off said casing, said lid having holes in it.

12. The combination of a structure as claimed in claim 5, and a cylindrical casing, each plate and membrane being in the form of an elongate strip, the structure being rolled and contained in said cylindrical casing.

13. An installation comprising a structure as defined in claim 1, a power consuming device connected across the tabs of the third and fourth plates, and, a source of DC current connected across the tabs of the first and second plates.

14. A structure as claimed in claim 6, and including an electrically insulating mesh between the first and third plates and a further electrically insulating mesh between the second and fourth plates, the first and third plates and the intervening mesh being pasted with electrochemically active positive material to form a composite plate and the second and fourth plates and the intervening mesh being pasted with electrochemically active negative material to form a further composite plate, the composite plate being separated by a gas permeable membrane.

15. A structure as claimed in claim 6, wherein the plates and membranes are of rectangular form.

16. A structure as claimed in claim 7, wherein the plates and membranes are of rectangular form.

17. The combination of a structure as claimed in claim 6, and a casing in which the structure is contained, the casing having a groove extending down in the internal face of each side wall and across the top face of the bottom of the casing, said structure fitting in a gas and liquid tight manner in said groove.

18. The combination of a structure as claimed in claim 7 and a casing in which the structure is contained, the casing having a groove extending down in the internal face of each side wall and across the top face of the bottom of the casing, said structure fitting in a gas and liquid tight manner in said groove.

19. The combination of a structure as claimed in claim 8 and a casing in which the structure is contained, the casing having a groove extending down in the internal face of each side wall and across the top face of the bottom of the casing, said structure fitting in a gas and liquid tight manner in said groove.

20. The combination claimed in claim 10 and further including a lid for closing-off said casing, said lid having holes in it.
